(19) United States
(12) Patent Application Publication
(10) Pub. No.: US 2010/0072717 A1
(43) Pub. Date: Mar. 25, 2010

(54) Striper with adjustable handle

(75) Inventor: Miroslav Liska, Somis, CA (US)

Correspondence Address: GRACO MINNESOTA INC, PO BOX 1441, MINNEAPOLIS, MN, 55440, US

(73) Assignee: GRACO MINNESOTA, INC.

(21) Appl. No.: 12/387,684

(22) Filed: May 5, 2009

Related U.S. Application Data
(60) Provisional application No. 61/126,794, filed on May 6, 2008.

(51) Int. Cl. B62B 11/00; E01C 23/16

(52) U.S. Cl. 280/47.371; 404/93

(57) ABSTRACT

A striper apparatus and method, with an improved and customizable approach to height-adjusting and/or folding the handle, is provided. In one embodiment, a striper may be provided with a cart, a plurality of wheels attached to the cart, one or more adjustable clamps attached to a back portion of the cart, and one or more adjustable handles, wherein a first end on each of the handles is attached to the cart via the clamps. A means for depositing one or more lines on a surface is also provided. The handle may be U-shaped. The height of the handle apparatus is adjustable by loosening bolts on the clamps. Once the handle apparatus is at a desired height, the bolts on the clamps are tightened and the handle apparatus is prevented from moving up or down.

This application claims the benefit of provisional application Ser. No. 61/126,794 to Miroslav Liska, which was filed on 6 May 2008.

### BACKGROUND OF THE INVENTION

1. Field of the Invention

This invention relates to handles for wheeled devices and more particularly to adjustable handles for use with line stripers and the like.

2. Description of the Related Art

Various stripers have been developed over the years for use in laying down stripes on various surfaces, and line striper devices are well known in the art. See, e.g. U.S. Pat. No. 4,877,348 to Opie and U.S. Patent App. No. 2008/0099579 to Schroeder, et al. Various handles have been developed for use with line stripers and other similar wheeled devices. However, people of varying heights utilize such devices, and many handles known in the art are rigid and incapable of being height-adjusted. It is thus desirable to incorporate handles that can be appropriately adjusted and customized for each individual user.

Additionally, line stripers and like devices are often stored in between uses and/or transported from one destination to another. However, many handles known in the art are incapable of being adjusted so the overall device takes up less space. It is thus desirable to provide a handle that is capable of being movably positioned and/or folded down so the handle can be moved out of the way or its overall size can be minimized. Such features are particularly applicable in circumstances where space might be a premium, such as when a striper or like device is put in storage or transported to another location.

### SUMMARY OF THE INVENTION

The present invention seeks to provide adjustable handles for line stripers and the like with an improved and customizable approach to adjusting and positioning handles for different heights, storage, transportation, and further uses, with the handles being durable, inexpensive, and easy to operate and adjust. In at least one embodiment according to the present invention, a striper is provided comprising a cart, a plurality of wheels attached to the cart, one or more adjustable clamps attached to a back portion of the cart, and one or more adjustable handles, with a first end of the handles attached to the cart via the clamps. Further, the striper comprises a means for depositing one or more lines on a surface.

In another embodiment according to the present invention, a striper is provided comprising a cart, a plurality of wheels attached to the cart, and one or more adjustable clamps attached to a back portion of the cart. Furthermore, the striper comprises an adjustable U-shaped handle, wherein a bottom portion of the U-shaped handle is attached to the cart via the clamps. Additionally, a means for depositing one or more lines on a surface is provided.

In another embodiment according to the present invention, a method is provided for a striper with adjustable handles. The method comprises providing a cart with a plurality of wheels and providing one or more adjustable clamps attached to a back portion of the cart. Additionally, the method comprises providing one or more adjustable handles and attaching the handles to the cart via the clamps, and adjusting the height of the handles by loosening the clamps and movably positioning the handles to a desired height. Finally, the method comprises stabilizing the handles at the desired height by tightening the clamps such that the handles are no longer movably height-adjusted.

These and other further features and advantages of the invention will be apparent to those skilled in the art from the following detailed description, taken together with the accompanying drawings, in which:

### BRIEF DESCRIPTION OF THE DRAWINGS

FIG. 1 is a right perspective view of one embodiment of a striper with adjustable handles according to the present invention;

FIG. 2 is a left perspective view of the striper with adjustable handles as shown in FIG. 1;

FIG. 3 is a perspective view of the adjustable handles shown in FIG. 1;

FIG. 4 is a right perspective view of one embodiment of a striper with an adjustable handle according to another embodiment of the present invention;

FIG. 5 is a left perspective view of the striper with adjustable handle as shown in FIG. 4;

FIG. 6 is a perspective view of the adjustable handle shown in FIG. 4; and

FIG. 7 is a perspective view of a line striper system with adjustable handles according to an embodiment of the present invention.

### DETAILED DESCRIPTION OF THE INVENTION

The following description presents several possible embodiments. This description is not to be taken in a limiting sense, but is made merely for the purpose of describing the general principles of the invention, the scope of which is further understood by the appended claims.

The present invention generally provides a line striper with an adjustable handle system for laying down a line on a variety of surfaces. This line striper with adjustable handles, among other advantages, allows for the striper to be easily height-adjusted for a variety of users. Additionally, the adjustable handle system allows the striper to take up less space when it is transported or placed in storage. Other advantages of the line striper with adjustable handles according to the present invention include being: durable, incomplex, easily adjustable, and customizable to a variety of desired applications.

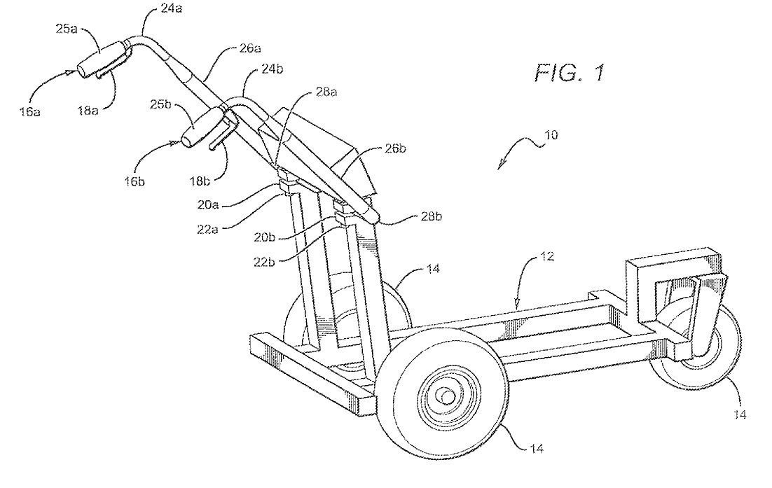

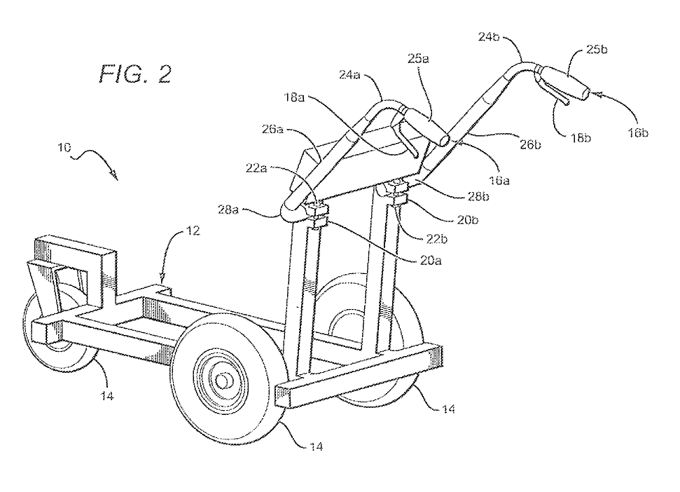

FIGS. 1 and 2 show one embodiment of a line striper 10 constructed in accordance with the present invention, having a cart 12, wheels 14 attached to cart 12, handles 16a, 16b, triggers 18a, 18b, clamps 20a, 20b, and bolts 22a, 22b. Some portions of the line striper 10 are omitted from the figures and/or will not be discussed herein as they are well known in the art and not pertinent to the function of the new adjustable handles. The main body portion of cart 12 and handles 16a, 16b are preferably formed from a durable metal such as welded steel, but it is understood that they can be formed from a number of different materials. While line striper 10 shows one preferred embodiment of a device comprising the new adjustable handle(s), it is understood that various wheeled devices may comprise at least one such handle.

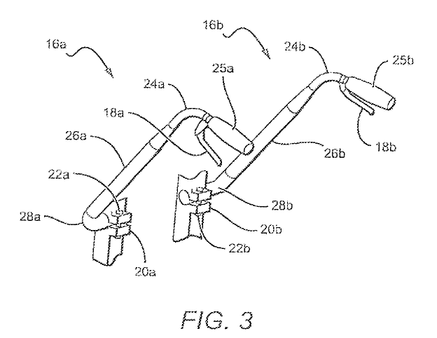

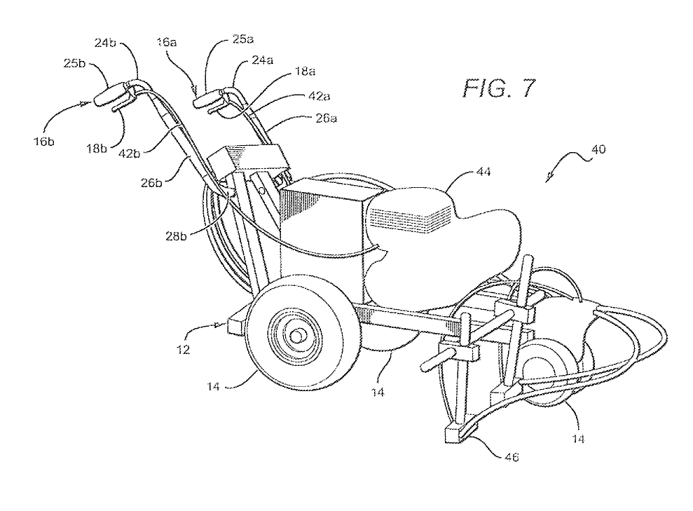

As can be seen in FIGS. 1-3 and 7 but best shown in FIG. 3, the handles 16a, 16b of the line striper 10 include triggers 18a, 18b extending first perpendicularly from and then parallel to first portions 24a, 24b of said handles 16a, 16b. Triggers 18a, 18b are capable of controlling cables 42a, 42b for operating a respective engine 44 and spray gun 46 (see FIG. 7). First portions 24a, 24b are preferably curved, and also include grip portions 25a, 25b where a user may easily hold onto the handles 16a, 16b to more easily control and maneuver line striper 10. Grip portions 25a, 25b may be comprised of a number of various suitable gripping materials, such as rubber, plastic, or leather.

The handles 16a, 16b also comprise elongated second portions 26a, 26b, which are preferably hollow. First portions 24a, 24b may be made from the same piece of metal or other durable material as elongated second portions 26a, 26b, and later bent into position during the manufacturing process. Alternatively, first portions 24a, 24b may initially be separate pieces from second portions 26a, 26b, which must be subsequently fitted into place. In one preferred embodiment, the diameter of first portions 24a, 24b is smaller than the diameter of second portions 26a, 26b such that the ends of first portions 24a, 24b can be slid into place within the topmost ends of second portions 26a, 26b, and held in place using a variety of methodologies, such as an o-ring, adhesive, or the like. Having this latter arrangement whereby the respective first and second portions are initially separate pieces can be advantageous because it allows the first portions 24a, 24b to be perpendicularly rotated with respect to second portions 26a, 26b. This can allow for first portions 24a, 24b to be folded in or out for customization and comfort for the user and/or for making the handles smaller for storage and transportation purposes. Additionally, the first portions 24a, 24b can be raised or lowered with respect to second portions 26a, 26b, allowing one means of height adjustment for the customization and comfort of the user.

The handles 16a, 16b also comprise lower L-shaped portions 28a, 28b, which are held in place on the cart 12 using respective clamps 20a, 20b. These lower portions 28a, 28b may be made from the same piece of metal or other durable material as elongated second portions 26a, 26b, and later bent into position during the manufacturing process. Alternatively, lower portions 28a, 28b may initially be separate pieces from second portions 26a, 26b, which must be fitted into place as described above with respect to first portions 24a, 24b. As such, the diameter of at least one end of lower portions 28a, 28b must be smaller than the diameter of at least one end of second portions 26a, 26b. Alternatively, the diameter of at least one end of second portions 26a, 26b must be smaller than the diameter of at least one end of lower portions 28a, 28b.

Clamps 20a, 20b fit around the ends of respective portions 28a, 28b opposite from the ends attached to second portions 26a, 28b, and are then tightened down upon portions 28a, 28b by rotating bolts 22a, 22b into place. When clamps 20a, 20b are not tightened down around portions 28a, 28b, the entire respective handle 16a, 16b is rotatably movable up or down for the purpose of height adjustment or to fold the handle into the line striper device 10 to put it out of the way for storage and/or transportation purposes. When either handle 16a or 16b is positioned in a desirable configuration, the respective bolt 22a, 22b may be rotated into place such that the respective clamp 20a, 20b is tightened down to hold the handle in place. While a clamp and bolt configuration is a preferred means for holding the handles in place, it is understood that other means, such as fixed holes and pins or fixed threaded holes and screws, are also appropriate.

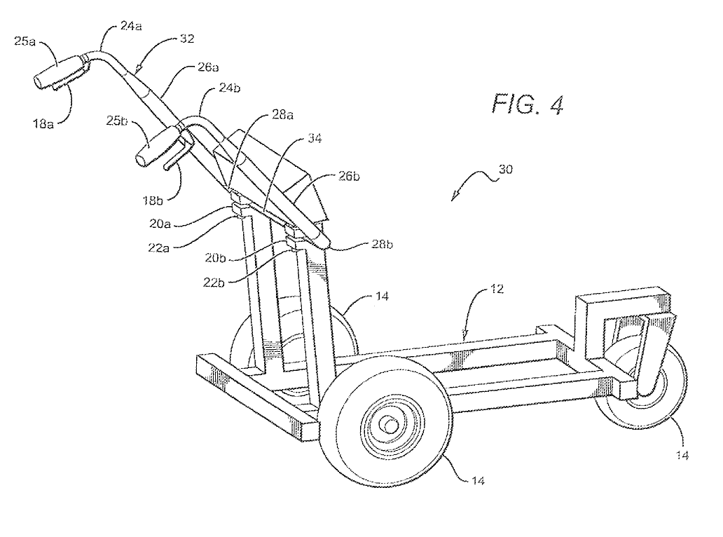

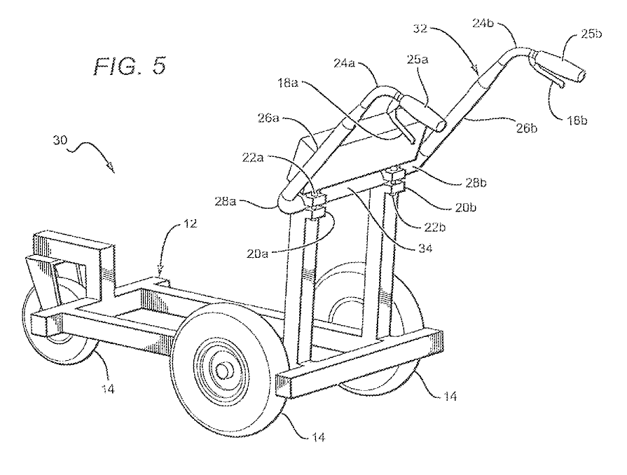

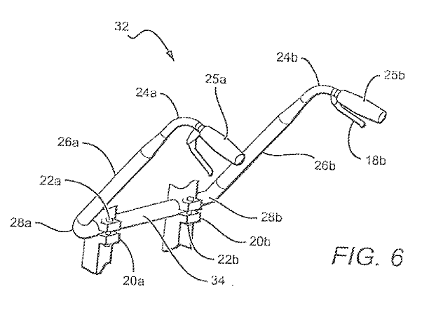

FIGS. 4 and 5 show another embodiment of a line striper 30 similar to the striper 10 depicted in FIGS. 1 and 2, having cart 12, wheels 14, triggers 18a, 18b, clamps 20a, 20b, bolts 22a, 22b, first portions 24a, 24b, grip portions 25a, 25b, second elongated portions 26a, 26b, and lower portions 28a, 28b. However, FIGS. 4-6 depict a different handle apparatus 32, which is generally U-shaped (best shown in FIG. 6). Center section 34 connects the bottom of the left and right sides of the handle apparatus 32 at lower portions 28a, 28b, and may be made from the same piece of metal or other durable material as first portions 24a, 24b, elongated second portions 26a, 26b and/or lower portions 28a, 28b and later bent into position during the manufacturing process. Alternatively, center section 34 may initially be a separate piece from first portions 24a, 24b, elongated second portions 26a, 26b and/or lower portions 28a, 28b, which must be fitted into place using methods as described above.

Apart from the center section 34 connecting the left and right sides of the handle apparatus 32 as described above, it is understood that all other elements of line striper 30 function and interact in the same ways as described above with respect to line striper 10 and FIGS. 1 and 2. Additionally, the same preferred embodiments described with respect to line striper 10 above likewise apply to line striper 30.

The adjustable handle of the present invention has a number of advantages over handles for other line striper devices known in the art. For example, in other line striper devices, the handles are not capable of being movably adjusted such that the height of the handles can be changed to accommodate various users with differing handle height requirements. Additionally, other line striper device handles are not capable of being movably adjusted such that the handles can fold down to create more room in tight spaces when the device is stored and/or transported. Moreover, other line striper device handles are not comprised of a plurality of portions that are capable of rotational movement such that orientation of the handles can be further adjusted and customized for any individual user or various storage/transportation purposes.

In operation, a user for the line striper device is identified, and then the height for the handle apparatus can be adjusted to coincide with the desired handle height of the user. To adjust the handles, the bolts 22a, 22b of the clamps 20a, 20b are loosened such that clamps 20a, 20b lose a firm grip around the lower portions 28a, 28b of the handle. The handles are then raised or lowered, and once they are at a desired height, bolts 22a, 22b are tightened such that clamps 20a, 20b form a tight fit around lower portions 28a, 28b.

Although the present invention has been described in considerable detail with reference to certain preferred configurations, other versions are possible. The invention can be used in many different types of wheeled devices. Different handle shapes, adjustment means, handle configurations, clamps, and handle accessories can be used in conjunction with the new adjustable handle. Therefore, the spirit and scope of the above description should not be limited to the versions described above.

We claim:

1. A striper comprising:
a cart;
a plurality of wheels attached to said cart;
one or more adjustable clamps attached to a back portion of said cart;
one or more adjustable handles, wherein a first end on each of said handles is attached to said cart via said clamps; and
a means for depositing one or more lines on a surface.

2. The striper of claim 1, further comprising a trigger on each of said handles.

3. The striper of claim 2, wherein one of said triggers functions to control a cable for operating an engine.

4. The striper of claim 2, wherein one of said triggers functions to control a cable for operating a spray gun.

5. The striper of claim 1, wherein each of said clamps further comprise a respective bolt, with the loosening of said bolt allowing an attached handle to be height-adjusted as desired.

6. The striper of claim 5, wherein the tightening of said bolt causes a respective clamp to tighten around an attached handle such that height-adjustment of said handle is prevented.

7. The striper of claim 1, wherein said cart and said handles are comprised of a durable metal.

8. The striper of claim 1, wherein each of said handles further comprise a curved first portion, an elongated second portion, and a curved third portion.

9. The striper of claim 8, wherein said first portion further comprises a grip portion for holding onto said handle.

10. The striper of claim 8, wherein said first, second, and third portions are all rotatably movable with respect to one another.

11. The striper of claim 8, wherein one end of said third portion is attached within a respective said clamp.

12. The striper of claim 1, wherein said means for depositing one or more lines on a surface comprises a spray gun and an engine operable to extract paint from a reservoir on said cart and expel said paint onto a desired surface.

13. A striper comprising:
a cart;
a plurality of wheels attached to said cart;
one or more adjustable clamps attached to a back portion of said cart;
an adjustable U-shaped handle, wherein a bottom portion of said U-shaped handle is attached to said cart via said clamps and two handle portions of said handle extend outward from said cart; and
a means for depositing one or more lines on a surface.

14. The striper of claim 13, further comprising a trigger on both of said handle portions opposite said bottom portion.

15. The striper of claim 14, wherein one of said triggers functions to control a cable for operating an engine and the other of said triggers functions to control a cable for operating a spray gun.

16. The striper of claim 13, wherein each of said clamps further comprise a respective bolt, with the loosening of said bolts allowing said attached handle to be height-adjusted as desired.

17. The striper of claim 16, wherein the tightening of said bolts causes respective clamps to tighten around said attached handle such that height-adjustment of said handle is prevented.

18. The striper of claim 13, wherein said handle portions extending outward from said cart each comprise a curved first portion, an elongated second portion, and a curved third portion.

19. The striper of claim 18, wherein said first portion further comprises a grip portion for holding onto said handle.

20. The striper of claim 18, wherein said first, second, and third portions are all rotatably movable with respect to one another.

21. The striper of claim 18, wherein said third portions join to form the bottom portion of said U-shaped handle.

22. The striper of claim 13, wherein said means for depositing one or more lines on a surface comprises a spray gun and an engine operable to extract paint from a reservoir on said cart and expel said paint onto a desired surface.

23. A method for a striper with adjustable handles comprising:
providing a cart with a plurality of wheels;
providing one or more adjustable clamps attached to a back portion of said cart;
providing one or more adjustable handles and attaching said handles to said cart via said clamps, and adjusting the height of said handles by loosening said clamps and movably positioning said handles to a desired height; and
stabilizing said handles at said desired height by tightening said clamps such that said handles are no longer movably height-adjusted.

24. The method of claim 23, further comprising providing said handles with one or more attached portions that are rotatably movable with respect to one another, and rotating said portions such that said handles are adjusted to a desired configuration.
